(19) United States
(12) Patent Application Publication
(10) Pub. No.: US 2006/0028418 A1
(43) Pub. Date: Feb. 9, 2006

(54) Method of pre-charge scanning for TFT-LCD panel

(75) Inventors: Liao Mu-Shan, Padeh City (TW); Tseng Wen-Tse, Padeh City (TW)

Correspondence Address: BACON & THOMAS, PLLC, 625 SLATERS LANE, FOURTH FLOOR, ALEXANDRIA, VA, 22314, US

(73) Assignee: ChungHwa Picture Tubes, LTD., Padeh City (TW)

(21) Appl. No.: 10/913,414

(22) Filed: Aug. 9, 2004

(51) Int. Cl. G09G 3/36

(52) U.S. Cl. 345/96

(57) ABSTRACT

A polarity inversion scanning method with several embodiments applicable to thin film transistor (TFT) liquid crystal display (LCD) is disclosed. The method charges two scanning lines at a time. The method decreases charge time of the TFT to the liquid crystal display, increases frame rate, and increases aperture ratio by possible smaller TFT design.

### BACKGROUND OF THE INVENTION

1. Field of the Invention

The invention generally relates to a scanning method of thin film transistor liquid crystal display (TFT LCD), and in particular relates to a polarity inversion scanning method applicable to TFT LCD panel.

2. Description of Related Art

TFT liquid crystal displays (LCD) have been widely used in many fields recently due to their advantages of lightweight and low power consumption. As shown in FIG. 1, an LCD mainly includes an array of a plurality of pixels, TFT switches 40 responsive to the pixels, a scanning or gate driver 10, a data or source driver 20 ,and a signal driving circuit 30 for supplying signals to the gate driver 10 and the source driver 20. The gate driver 10 connects to a first row of gates through a first scanning line G(1); connects to a second row of gates through a second scanning line G(2), and so on till a last scanning line G(n) of a last row of gates. Each scanning line passes the scanning signal to each TFT gate of pixels on the same line upon receiving control signal from the signal driving circuit 30. On the other hand, the source driver 20 also electrically connects the vertically first D(1), second D(2), till the last data lines D(M) to each TFT source of the pixels. The data signals provided by the source driver 20 charge each pixel on a row to a specific voltage for showing different colors. The gate driver 10 shuts off the voltage of a row when charges of the row are finished. The process continues for each scanning line of the pixel array. The LCD device is usually driven with 60 Hz alternative voltage for polarity inversion of pixel electrodes and common electrodes. The polarity inversion takes place in each frame time of adjacent pixels scanning so as to prevent the liquid crystal molecules from fission and decreasing the image quality. As shown in FIG. 2, a conventional polarity inversion method is frame inversion. It alternatively changes the relative polarities of pixel electrodes to the common electrode in adjacent frames. However, caused by voltage deviation of the common electrode and impurities in the liquid crystal cells, the voltage between the electrodes is nonsymmetrical that the positive voltage and the negative voltage have different effective values. It causes luminance vibrations that a 30 Hz frequency data blinks under a 60 Hz scanning rate. As shown in FIG. 3, in order to improve the phenomenon, a line inversion method has been developed. It reverses the polarities of one or several rows of pixels during two adjacent frame times. The scanning lines of one and several rows are reversed in polarity. Therefore, even the positive and negative voltages of data have different effective values between this and the prior frames, the difference of effective value is spatially cancelled to suppress the 30 Hz flicker, and the image quality is improved.

As shown in FIG. 4, a conventional scanning scans once a row only. That is, on each time, only the TFTs on the same scanning line are charged. For the first to the last scanning lines G(1), G(2) . . . G(n−1), G(n), scanning is applied one by one from the first scanning line G(1) to the last scanning line G(n) in a specific time interval. The G(1) to G(n) scanning repeats in a next frame time and cycles.

The major drawback of conventional scanning is that the charge is insufficient when the TFT is not well designed or the scanning frequency is increased so as to decrease the charge time. It causes problems of poor image quality and low contrast.

### SUMMARY OF THE INVENTION

The object of the invention is to provide methods of pre-charging scanning lines of TFT LCD for solving the problem of insufficient charge of conventional one-line scanning. The new method decreases charge time so as to work on higher frame rate; moreover, the aperture ratio is increased by possible smaller TFT design.

Based on conventional polarity inversion, the invention provides the following pre-charge methods:
1. Single line (1Line) inversion: as shown in FIG. 5A, during the scanning signal charging on each a scanning line, a same polarity pre-charge is taking place on the TFT on upper or lower adjacent second scanning line;
2. Double line (2Line) inversion: as shown in FIG. 6A, during the scanning signal charging on each a scanning line, a same polarity pre-charge is taking place on the TFT on upper or lower adjacent fourth scanning line;
3. Single and double (1+2Line) inversion: as shown in FIG. 7A, during the scanning signal charging on each a scanning line, a same polarity pre-charge is taking place on the TFT on upper or lower adjacent fourth scanning line.

### BRIEF DESCRIPTION OF THE DRAWINGS

The invention will become more fully understood from the detailed description given herein below. However, this description is for purposes of illustration only, and thus is not limitative of the invention, wherein:

FIG. 1 is circuit constructional view of a conventional thin film transistor (TFT) LCD;

FIG. 2 is a descriptive view of a conventional frame inversion for polarity inversion of TFT LCD panel;

FIG. 3 is a descriptive view of a conventional line inversion for polarity inversion of TFT LCD panel;

FIG. 4 is a descriptive view of conventional scanning method for TFT LCD;

FIG. 5A is a descriptive view of a single line (1Line) inversion of the invention;

FIG. 5B is a descriptive view of scanning pulse of a 1Line inversion of the invention;

FIG. 6A is a descriptive view of a double line (2Line) inversion of the invention;

FIG. 6B is a descriptive view of scanning pulse of a double line (2Line) inversion of the invention;

FIG. 7A is a descriptive view of a single and double line (1+2Line) inversion of the invention; and

FIG. 7B is a descriptive view of scanning pulse of a single and double line (1+2Line) inversion of the invention.

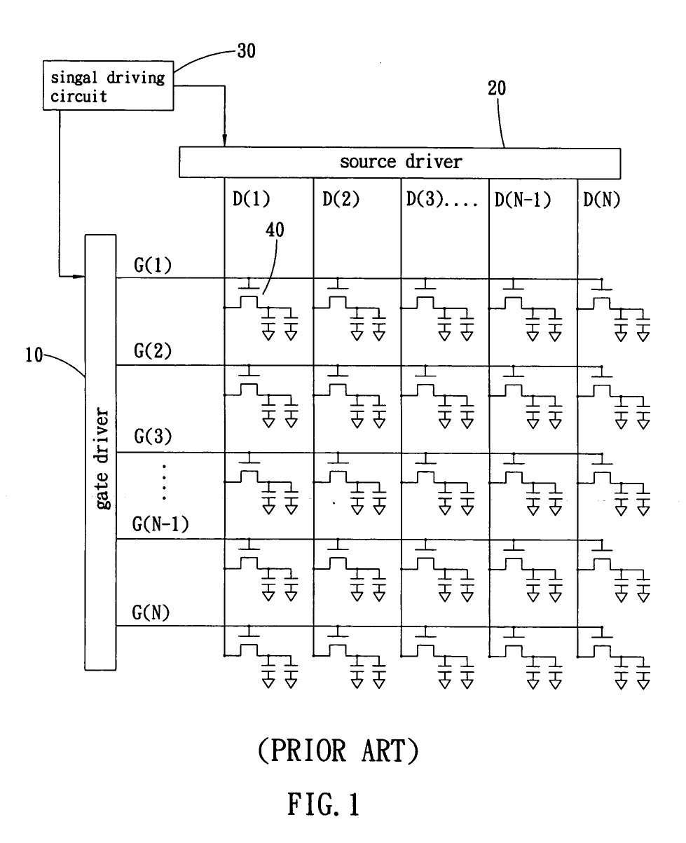

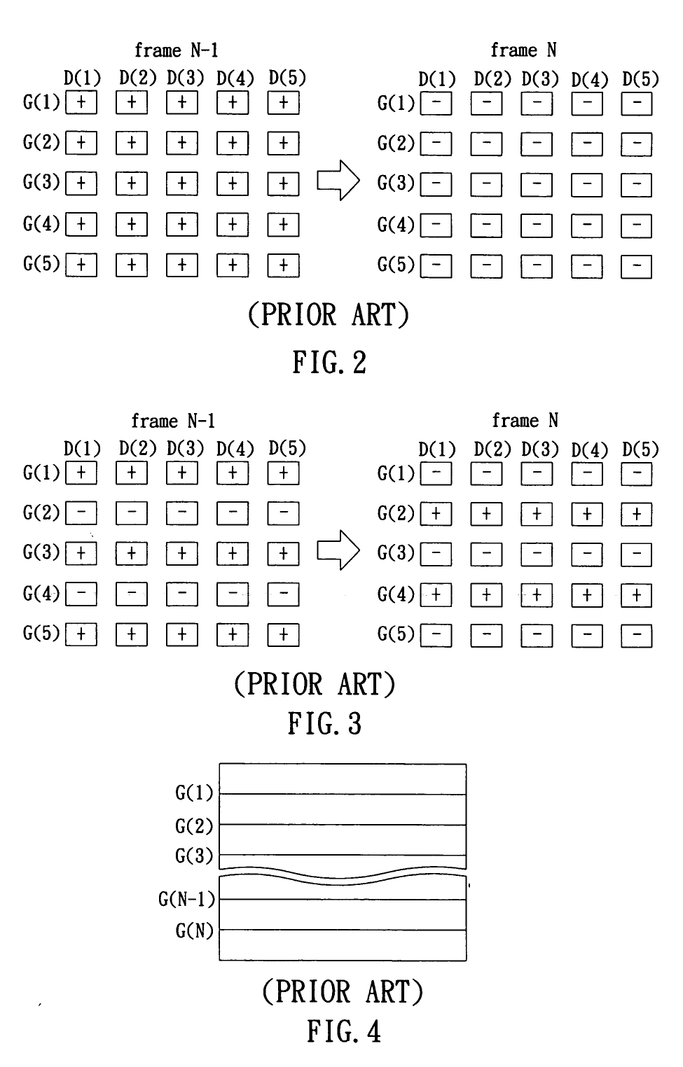

### DESCRIPTION OF THE PREFERRED EMBODIMENTS

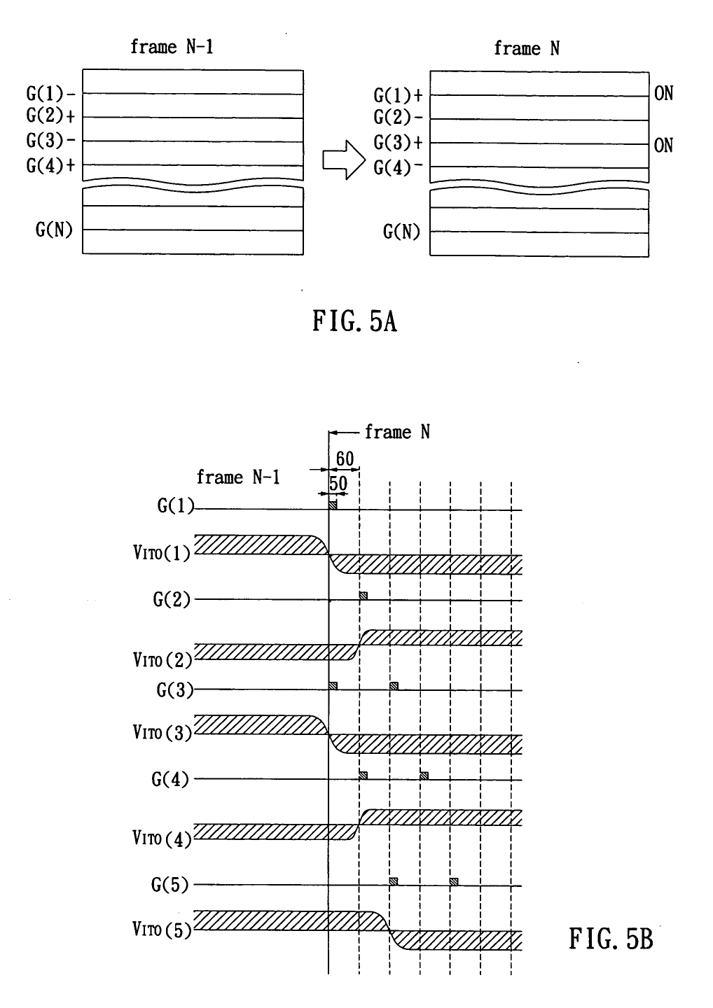

FIGS. 5A and 5B illustrate an embodiment of the invention applicable to thin film transistor liquid crystal display panel in which polarity of each adjacent scanning line is reversed. Instead of conventional charge of “once a line”, the gate driver of the invention charges two scanning lines at a time. The driving sequence is as follows. On a prior frame(N−1), the polarity of each adjacent scanning line is reversed. For example, the voltage of pixel electrode of a first scanning line G(1) is negative relatively to the common electrode, then, the voltage of pixel electrode of the second scanning line G(2) is positive relatively to the common electrode; the voltage of pixel electrode of the third scanning line G(3) is negative relatively to the common electrode; and so on. Then, on the current frame N for polarity inversion, each scanning line is driven by periodical electrical pulse. The scanning cycle 50 of electrical pulse is about half or less than half of the horizontal scanning cycle 60. When electrical pulse is provided to the gate of TFT on the first scanning line G(1) to turn it on and signal provided by the source driver 20 passes to the electrode to charge, the gate of TFT on the third scanning line G(3) is synchronously opened to receive the source signal for a pulse scanning cycle. The pulse scanning cycle is determined by the frame time divided by the number of total scanning lines. For example, with a 60 Hz scanning rate, the frame time is 1/60 second; for a display resolution of 1024*768 XGA, the scanning lines are 768 rows, then, the pulse scanning cycle time for each scanning line is 1/60/768 or about 21.7 microseconds. After a pulse scanning cycle is finished, the gate signals of the first and third scanning lines G(1), G(3) are turned off, the second scanning line G(2) is then scanned. Meanwhile, a same polarity of the second scanning line G(2) is applied on the fourth scanning line G(4) for pre-charge. Afterwards, when scanning on the third scanning line G(3), the charge is easily finished in the pulse scanning cycle because it has been pre-charged during the prior stage of scanning the first scanning line G(1). The sequence of scanning from the first to the last scanning line is G(1)/G(3), G(2)/G(4), G(3)/G(5) . . . G(N−2)/G(N).

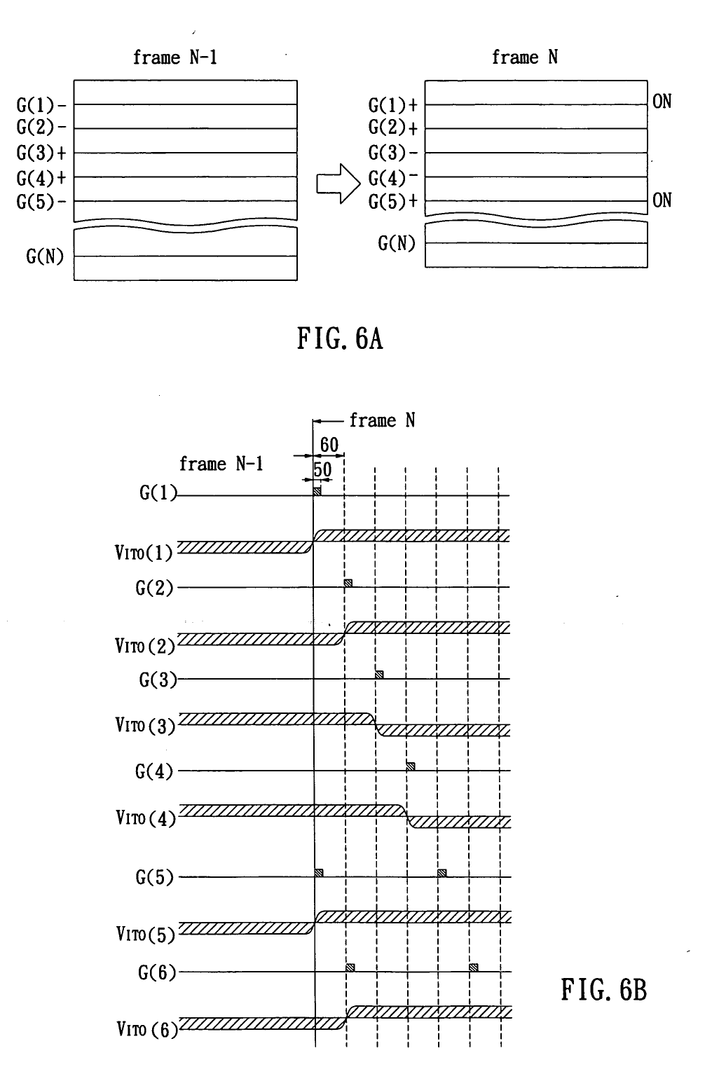

FIGS. 6A and 6B illustrate an embodiment of the invention applicable to thin film transistor liquid crystal display panel in which polarities of each two adjacent scanning lines are reversed. Instead of conventional charge of “once a line”, the gate driver of the invention charges two scanning lines at a time. The driving sequence is as follows. On a prior frame(N−1), the polarity of every two adjacent scanning lines is reversed. For example, the voltages of pixel electrodes of a first and a second scanning lines G(1), G(2) are negative relatively to the common electrode, and then the voltage of pixel electrodes of the third and fourth scanning lines G(3), G(4) are positive relatively to the common electrode; the voltages of pixel electrode of the fifth and sixth scanning lines G(5), G(6) are negative relatively to the common electrode; and so on. Then, on the current time frame N for polarity inversion, each scanning line is driven by periodical electrical pulse. When electrical pulse is provided to the gate of TFT on the first scanning line G(1) to turn it on and signal provided by the source driver 20 passes to the electrode to charge, the gate of TFT on the fifth scanning line G(5), instead of the third G(3), is synchronously opened to receive the source signal for a pulse scanning cycle. After a pulse scanning cycle is finished, the gate signals of the first and fifth scanning lines G(1), G(5) are turned off and the second and sixth scanning lines G(2), G(6) are then scanned. The correspondent two line scanning proceeds till the last scanning line G(N). In other words, the two scanning lines are coupled in a (+)(+)(−)(−) group sequence and correspondent with a four-line space in order to keep the same polarity.

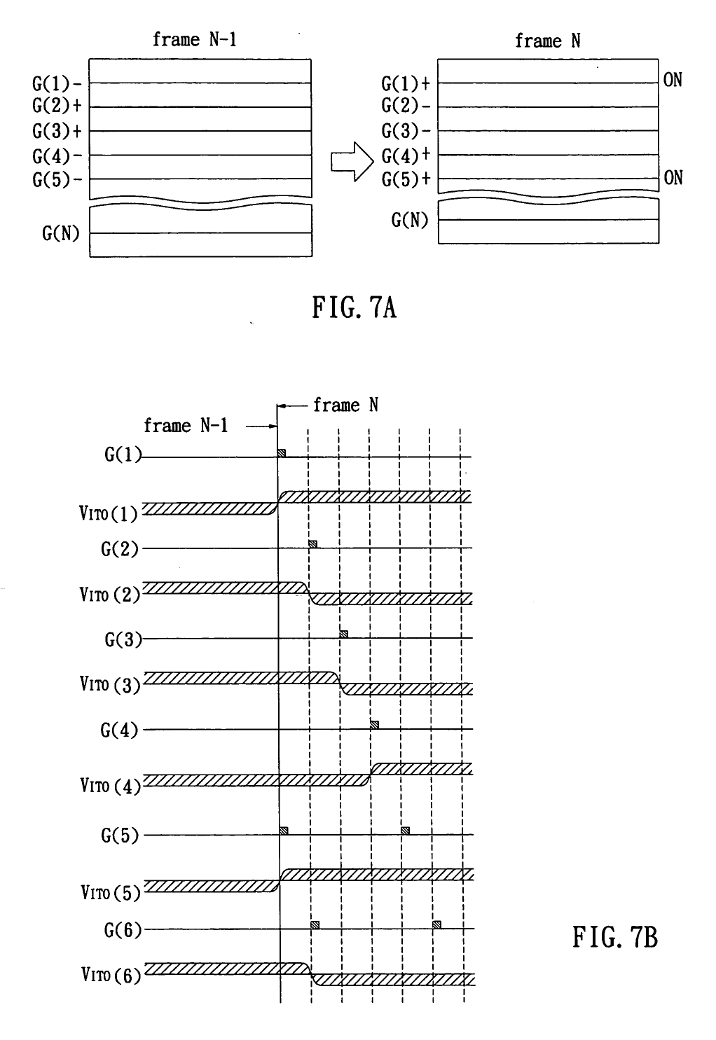

Similarly, FIGS. 7A and 7B illustrate an embodiment of the invention applicable to thin film transistor liquid crystal display panel in which the polarity of a first scanning line is independent and polarities of each two adjacent scanning lines of the rest are reversed. Instead of conventional charge of “once a line”, the gate driver of the invention charges two scanning lines at a time. The driving sequence is as follows. On a prior frame(N−1), the polarity of a first scanning line G(1) is independent, then every two adjacent scanning lines of the rest are reversed. For example, the voltage of pixel electrodes of the first scanning line G(1) is negative relatively to the common electrode, then, the voltage of pixel electrodes of the second and third scanning lines G(2), G(3) are positive relatively to the common electrode; the voltage of pixel electrode of the fourth and fifth scanning lines G(4), G(5) are negative relatively to the common electrode; and so on. Then, on the current frame N for polarity inversion, each scanning line is driven by periodical electrical pulse. When electrical pulse is provided to the gate of TFT on the first scanning line G(1) to turn it on and signal provided by the source driver 20 passes to the electrode to charge, the gate of TFT on the fifth scanning line G(5) is synchronously opened to receive the source signal for a pulse scanning cycle. After a pulse scanning cycle is finished, the gate signals of the first and fifth scanning lines G(1), G(5) are turned off, the second and sixth scanning lines G(2), G(6) are then scanned. The correspondent two line scanning proceeds till the last scanning line G(N). In other words, the two scanning lines are coupled in a (+)(−)(−)(+) group sequence and correspondent with a four-line space in order to keep the same polarity.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A pre-charging method applicable to two line scanning of a thin film transistor liquid crystal display panel in which polarity of each adjacent scanning line is reversed, comprising:
within a frame time, pre-charging TFT on an adjacent second scanning line during scanning TFT on each a scanning line; and
stopping charge of said TFTS on said each and second scanning lines when finishing charge on said each scanning line.

2. A pre-charging method according to claim 1 wherein said scanning and pre-charging are cycling downward; said adjacent second scanning line is an adjacent lower line.

3. A pre-charging method according to claim 1 wherein said scanning and pre-charging are cycling upward; said adjacent second scanning line is an adjacent upper line.

4. A pre-charging method according to claim 1 further comprises a step of proceeding said scanning and pre-charging for next lines after said step of stopping charge of said TFTS on said each and second scanning lines.

5. A pre-charging method according to claim 1 wherein all scanning lines are connected to a gate driver; said gate driver selectively scans two scanning lines of each a line and an adjacent line thereof at a time.

6. A pre-charging method applicable to two line scanning of a thin film transistor liquid crystal display in which polarities of each two adjacent scanning lines are reversed, comprising:
within a frame time, pre-charging TFT on a adjacent fourth scanning line during scanning TFT on each a scanning line; and
stopping charge of said TFTS on said first and fourth scanning lines when finishing charge on said each scanning line.

7. A pre-charging method according to claim 6 wherein said scanning and pre-charging are cycling downward; said adjacent fourth scanning line is an adjacent lower line.

8. A pre-charging method according to claim 6 wherein said scanning and pre-charging are cycling upward; said adjacent fourth scanning line is an adjacent upper line.

9. A pre-charging method according to claim 6 further comprises a step of proceeding said scanning and pre-charging for next lines after said step of stopping charge of said TFTS on said each and fourth scanning lines.

10. A pre-charging method according to claim 6 wherein all scanning lines are connected to a gate driver; said gate driver selectively scans two scanning lines of each a line and an adjacent fourth line thereof at a time.

11. A pre-charging method applicable to two line scanning of a thin film transistor liquid crystal display in which polarity of a first scanning line is independent and polarities of each two adjacent scanning lines of the rest are reversed, comprising:
within a frame time, pre-charging TFT on a adjacent fourth scanning line during scanning TFT on each a scanning line; and
stopping charge of said TFTS on said each and fourth scanning lines when finishing charge on said each scanning line.

12. A pre-charging method according to claim 11 wherein said scanning and pre-charging are cycling downward; said adjacent fourth scanning line is an adjacent lower line.

13. A pre-charging method according to claim 11 wherein said scanning and pre-charging are cycling upward; said adjacent fourth scanning line is an adjacent upper line.

14. A pre-charging method according to claim 11 further comprises a step of proceeding said scanning and pre-charging for next lines after said step of stopping charge of said TFTS on said each and fourth scanning lines.

15. A pre-charging method according to claim 11 wherein all scanning lines are connected to a gate driver; said gate driver selectively scans two scanning lines of each a line and an adjacent fourth line thereof at a time.
